(19) United States
(12) Patent Application Publication
(10) Pub. No.: US 2021/0284348 A1
(43) Pub. Date: Sep. 16, 2021

(54) MOUNTING SYSTEMS, DEVICES, AND METHODS FOR AIRCRAFT ENGINES

(71) Applicant: LORD Corporation, Cary, NC (US)

(72) Inventor: Gerald P. WHITEFORD, Waterford, PA (US)

(21) Appl. No.: 16/319,560

(22) PCT Filed: Aug. 8, 2017
(86) PCT No.: PCT/US17/45906

§ 371 Date: Jan. 22, 2019

Related U.S. Application Data
(60) Provisional application No. 62/371,895, filed on Aug. 8, 2016.

(51) Int. Cl. B64D 27/26

(52) U.S. Cl. CPC B64D 27/26; B64D 2027/266

(57) ABSTRACT

Engine mounting systems and methods that reduce engine core bending provide a first forward mount (130) connectable to a forward part of an engine core of an aircraft, an aft mount (150) connectable to an aft part of the core, and in a variant a second forward mount (140) connectable to the engine radially outward from the longitudinal axis of the engine with respect to the first forward mount, e.g. to a fan casing. The first forward mount reacts forces in a longitudinal, a lateral and a vertical direction. The aft mount reacts forces in the lateral direction and moments about the longitudinal direction, and in a variant vertical forces only from a predetermined pitch deflection of the engine. Stiffness values of the (first) forward and/or aft mount in the vertical direction may be reduced upon a fan blade off event. Where present, the second forward mount reacts forces in the longitudinal direction by being offset from the first forward mount such that reacting forces in the longitudinal direction by the forwards mounts reacts moments about the lateral direction.

### CROSS-REFERENCE TO RELATED APPLICATIONS

The present application claims the benefit of U.S. Provisional Patent Application Ser. No. 62/371,895, filed Aug. 8, 2016, the disclosure of which is incorporated herein by reference in its entirety.

### TECHNICAL FIELD

The subject matter herein generally relates to mounting systems, devices, and methods for aircraft engines. The subject matter herein more particularly relates to engine mount systems for turbofan engines.

### BACKGROUND

Engine mount systems for turbofan engines typically consist of multiple mounts to transmit the loads, including thrust, from the engine to the airframe. In underwing installations the engine mounts typically connect the engine to a pylon that is then in turn connected to the aircraft wing structure.

A typical mount system reacts vertical and lateral loads at the forward mount of the engine. This mount can be attached at a location on either the outer fan case as shown in U.S. Pat. No. 7,021,585 or the engine core similar to that shown in U.S. Pat. No. 8,950,702. The aft mount is typically attached to the engine turbine case and reacts lateral and vertical loads as well as the engine roll moment (i.e., moment about the engine thrust line). Engine thrust is typically reacted by a linkage system including a whiffletree. The links extend either from the aft side of the forward mount or from the aft mount position. All of these approaches result in thrust being reacted above the thrust axis with a resulting pitch moment that must be reacted by the forward and aft mounts as vertical loads. This results in a bending moment in the core of the engine (i.e., backbone bending). Various methods to alleviate this bending moment have been documented in the art including varying the thrust link angles and forward mount attachment angles to minimize the vertical loading at the rear mount due to engine thrust.

In addition, during climb or other conditions where the nacelle inlet is inclined relative to the airflow, an aerodynamic pitch moment is induced on the inlet and transmitted to the engine as the inlet is attached directly to the front of the engine. This moment must also be reacted by the engine mount system and can result in further backbone bending.

Accordingly, it would be desirable for a system to eliminate the bending moment in the engine core induced by thrust and by aerodynamic loading on the nacelle including that moment caused by the nacelle angle relative to airflow.

### SUMMARY

In one aspect, an engine mounting system is provided. The engine mounting system includes a first forward mount, an aft mount, and a second forward mount. The first forward mount is configured for connection between a structure of an aircraft and a first forward part of an engine of the aircraft. The first forward mount being configured to react forces generated in each of a longitudinal direction parallel to a longitudinal axis of the engine, in a lateral direction transverse to the engine, and in a vertical direction. The aft mount is configured for connection between the structure and an aft part of the engine. The aft mount being configured to react forces generated in the lateral direction and to react moments about the longitudinal direction. The second forward mount is configured for connection between the structure and a second forward part of the engine. The second forward mount being configured to react forces generated in the longitudinal direction. In this way, the second forward mount is offset by a distance from the first forward mount such that the reaction of first and second forwards mounts to forces in the longitudinal direction reacts moments about the lateral direction (e.g., pitch moments).

In another aspect, an engine mounting system is provided. The engine mounting system includes an engine, a structure, a first forward mount, an aft mount, and a second forward structure. The engine includes a fan casing. The structure is fixed under a wing. The first forward mount is configured for mounting the engine to the structure. The aft mount is configured for mounting the engine to the structure. The second forward mount is configured for opposing moments about a transverse lateral axis that is substantially orthogonal to a longitudinal axis of the engine, the second forward mount comprising a connecting rod configured for opposing moments about the transverse lateral axis of the engine, the connecting rod being directly connected to the structure and to the fan casing of the engine. In this way, the aft mount is configured to react forces generated in a vertical direction only after a pitch deflection of the engine exceeds a defined value.

In yet another aspect, a method for supporting an engine on an aircraft is provided. The method includes, at a first forward mount connected between a structure of an aircraft and a first forward part of an engine of the aircraft, reacting forces generated in a longitudinal direction parallel to a longitudinal axis of the engine, in a lateral direction transverse to the engine, and in a vertical direction. The method further includes, at an aft mount connected between the structure and an aft part of the engine, reacting forces generated in the lateral direction and reacting moments about the longitudinal direction. The method further includes, at a second forward mount connected between the structure and a second forward part of the engine, reacting forces generated in the longitudinal direction. In this way, the second forward mount is offset by a distance from the first forward mount such that reacting forces in the longitudinal direction by the first and second forwards mounts reacts moments about the lateral direction.

In still another aspect, an engine mounting system is provided. The engine mounting system includes at least one forward mount and an aft mount. The at least one forward mount is configured for connection between a structure of an aircraft and a forward part of an engine of the aircraft, the at least one forward mount being configured to react forces generated in a longitudinal direction parallel to a longitudinal axis of the engine, in a lateral direction transverse to the engine, and in a vertical direction. The aft mount is configured for connection between the structure and an aft part of the engine, the aft mount being configured to react forces generated in the lateral direction and in the vertical direction and to react moments about the longitudinal direction. One or both of the at least one forward mount or the aft mount is configured to have a stiffness that is reduced from a first stiffness value to a relatively lower second stiffness value of about 50% or less in the vertical direction upon a fan blade off event.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

FIG. 1A is a perspective view of a mounting system inserted between an aircraft engine and a structure of an attachment strut fixed under a wing of an aircraft according to an embodiment of the presently disclosed subject matter.

FIG. 1B is a side view of a mounting system inserted between an aircraft engine and a structure of an attachment strut fixed under a wing of an aircraft according to an embodiment of the presently disclosed subject matter.

FIG. 2A is a perspective view of a mounting system inserted between an aircraft engine and a structure of an attachment strut fixed under a wing of an aircraft according to an embodiment of the presently disclosed subject matter.

FIG. 2B is a side view of a mounting system inserted between an aircraft engine and a structure of an attachment strut fixed under a wing of an aircraft according to an embodiment of the presently disclosed subject matter.

FIG. 3 is a side view of a mounting system inserted between an aircraft engine and a structure of an attachment strut fixed under a wing of an aircraft according to an embodiment of the presently disclosed subject matter.

FIG. 4 is a perspective view of a mounting system in which a second forward mount is designed to act as a structural-mechanical “fuse” under a fan-blade-off event according to an embodiment of the presently disclosed subject matter.

FIGS. 5A and 5B are side perspective cutaway views of a mounting system in which a second forward mount is designed to act as a structural-mechanical “fuse” under a fan-blade-off event according to an embodiment of the presently disclosed subject matter.

FIG. 6 is a side view of a mounting system inserted between an aircraft engine and a structure of an attachment strut fixed under a wing of an aircraft according to an embodiment of the presently disclosed subject matter.

FIG. 7 is a sectional rear view of a fluidic torque restraint device used to decouple the vertical load and roll moment reaction of an aft mount of a mounting system according to an embodiment of the presently disclosed subject matter.

### DETAILED DESCRIPTION

The mount system disclosed herein comprises a first forward mount that reacts loads in the vertical and lateral directions (e.g., perpendicular to the thrust axis) and loads in a longitudinal direction parallel to a longitudinal axis of the engine (e.g., thrust loads). A second forward mount reacts loads in the thrust direction (e.g., axially or forward), such as by a link. The system also includes an aft mount that reacts loads in the lateral direction and moments about the thrust axis (e.g., roll). These mounts together react loads and moments in all directions and retain the engine to the aircraft. In this configuration, backbone or engine core bending and the associated decrease in engine efficiency are reduced or eliminated.

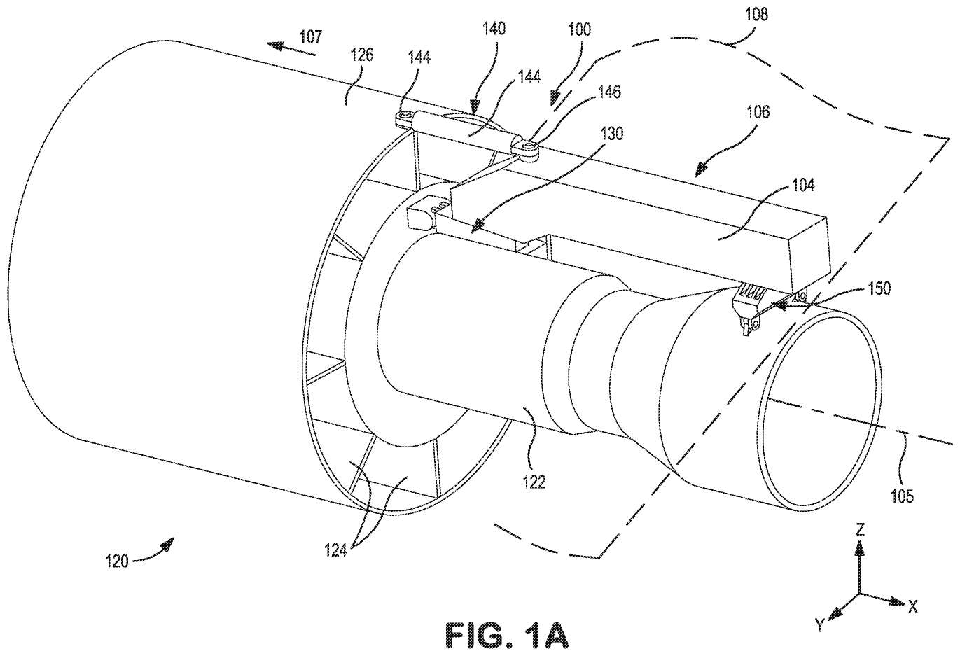

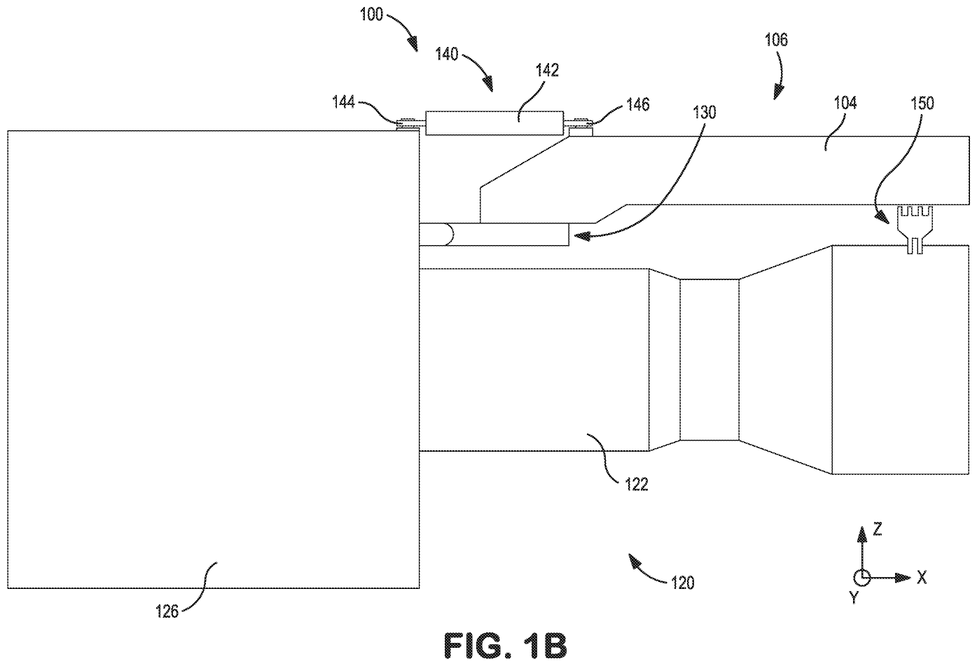

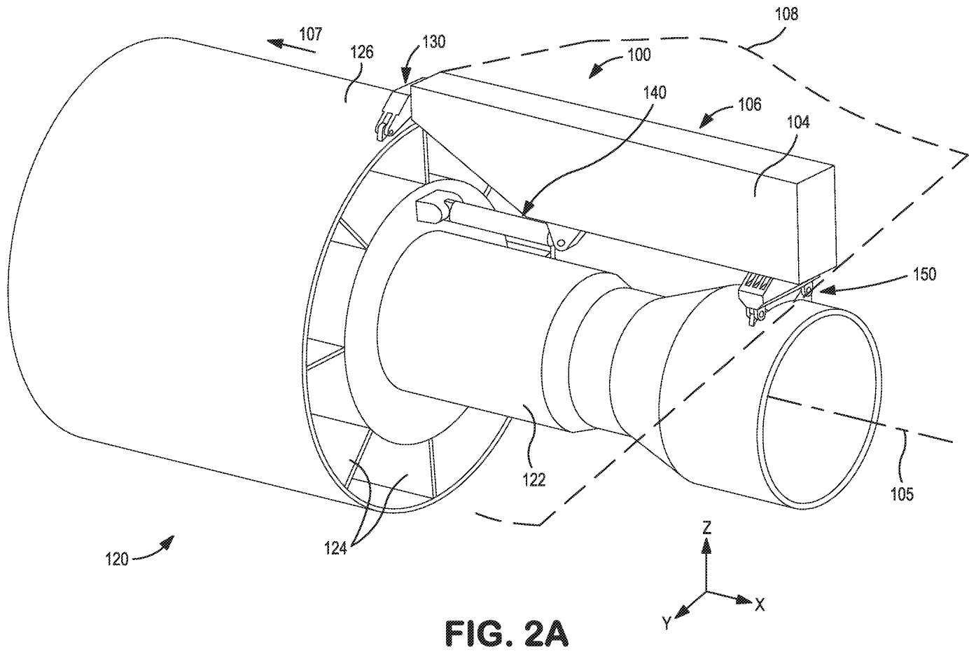

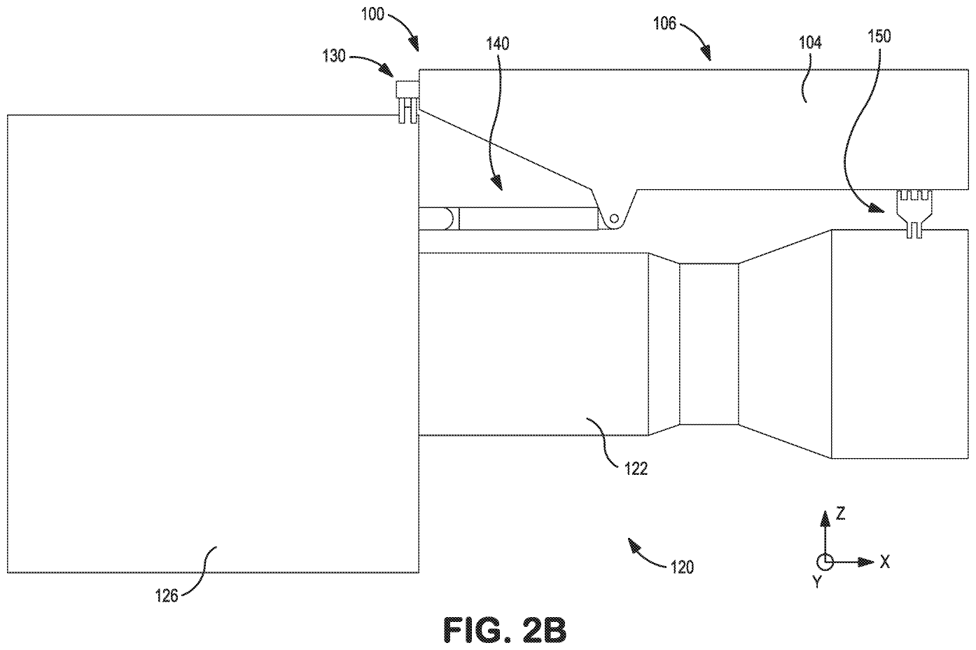

Figures (also “FIGS.”) 1A-7 illustrate various aspects, views, and/or features associated with improved engine mount devices, systems, and/or methods. Referring to the embodiments illustrated in FIGS. 1A-2B, a mounting system, generally designated 100, is inserted between an aircraft engine, generally designated 120, and a structure 104 (only a portion of which is illustrated in FIGS. 1A-2B) of an attachment strut or pylon 106 fixed under an aircraft wing, generally designated 108, which is shown only for reasons of clarity. As shown on these FIGS. 1A and 1B, aircraft engine 120 is a turbofan, but those having ordinary skill in the art will understand that mounting system 100 could be a system designed to suspend any other type of engine without departing from the scope of the invention.

Throughout the description given below, by convention, X is the direction parallel to a longitudinal axis 105 of engine 120, Y is the transverse direction of the aircraft, and Z is the vertical direction, these three directions being orthogonal to each other. Secondly, the terms ‘forward’ and ‘aft’ should be considered with respect to a direction of movement of the aircraft that takes place as a result of the thrust applied by engines 120, this direction being shown in FIGS. 1A and 2A by an arrow 107.

In the embodiment shown in FIGS. 1A and 1B, mounting system 100 comprises a first forward mount 130 that is coupled on or about the core of engine 120, an aft mount 150, and a second forward mount 140 that is displaced radially outward from the engine centerline from the forward mount on the fan case. Second forward mount 140 is designed to resist pitch moments about the Y-axis that tend to generate longitudinal bending of the engine 120. In this configuration, first forward mount 130 is fixed between a forward end of structure 104 and a forward part of a core 122 of engine 120. In some embodiments, first forward mount 130 penetrates into a portion of core 122 on which fixed blades 124 are fitted connecting a fan casing 126 of engine 120 to core 122. In some embodiments, first forward mount 130 comprises generally a ball joint (not shown), also called a monoball, which transmits X, Y, and Z directional forces from engine 120 to the airframe without transmitting moments to the airframe. The monoball may be contained inside core 122 or outside of engine 120.

Still referring to the embodiment illustrated in FIGS. 1A and 1B, second forward mount 140 is mounted radially outward from first forward mount 130 to permit pitch moment reaction (e.g., caused by thrust reaction offset from the thrust line and/or aerodynamic loads on the nacelle) at the front of engine 120 through core 122. In the embodiment illustrated in FIGS. 1A and 1B, second forward mount 140 comprises a connecting rod 142 configured to react forces in the longitudinal direction and thereby resist longitudinal bending about the transverse axis of engine 120. This is the moment that existing mounting systems generate longitudinal bending in engine 120. In this embodiment, there is no vertical load reaction in the aft mount 150. The loads at the front of engine 120 remove the moment about the lateral axis. Core 122 is not involved in reacting the moment about the transverse axis. Second forward mount 140 also comprises a first fitting 144 and a second fitting 146. First fitting 144 connects the forward end of connecting rod 142 to the fan casing 126 (e.g., to an aft part of fan casing 126 at an upper and outer end portion of the casing). Second fitting 146 connects the aft end of rod 142 to structure 104 of pylon 106, for example using a ball joint. In some embodiments, connecting rod 142 is connected to a forward part of structure 104 as is shown in FIG. 1. Regardless of the particular connection arrangement, in some embodiments, connecting rod 142 is located in a vertical fictitious plane passing through longitudinal axis 105 of engine 120, and is approximately oriented along the longitudinal X direction. In this arrangement, second forward mount 140 is configured as a link to avoid reacting engine loads in the lateral and vertical directions perpendicular to its axis.

In the embodiment illustrated in FIGS. 2A and 2B, the relative arrangement of first forward mount 130 and second forward mount 140 is substantially reversed such that second forward mount 140 is coupled on or about the core of engine 120, and first forward mount 130 is displaced radially outward from the engine centerline from the forward mount on the fan case. In this arrangement, first forward mount 130 is again configured to react the vertical, lateral, and longitudinal loads, and second forward mount 140 is configured to react the substantially longitudinal force only.

Regardless of the particular configuration of first and second forward mounts 130 and 140, aft mount 150 is fixed between an aft part of core 122 and structure 104 of pylon 106. In some embodiments, aft mount 150 comprises devices and fittings configured to resist forces along the Y direction and resist the moment applied about the X direction. In some embodiments, devices such as those detailed in U.S. Pat. No. 5,108,045 or 4,805,851 provide a mechanism where moments about an axis can be decoupled form vertical load reaction by use of a torque tube. These kinds of devices are also common in turboprop installation (See, e.g., U.S. Pat. No. 5,127,607). In this configuration, little to no vertical load is reacted by aft mount 150.

This general arrangement prevents loading of aft mount 150 in the vertical direction and bending in core 122 due to thrust and aerodynamic loads generating moments about the lateral Y-axis. Engine core 122 of engine 120 is thus essentially cantilevered from a forward portion of engine 120 relative to vertical loads and only supports its own weight, minimizing bending. In addition, as the design of the bypass ratio of engines is increased and core 122 becomes smaller relative to the size of fan casing 126 and the thrust output, the ability of core 122 to withstand the bending moment of conventional mountings is decreased. The design of mounting system 100 thus becomes more effective as the engine bypass ratio increases and the fan diameter becomes larger relative to the size of core 122. Thereby allowing for increased distance between the first forward mount 130 and second forward mount 140, and providing an improved ability to react the moment about the transverse Y-axis, which reduces the load in the thrust direction (i.e., longitudinal direction) at the forward mounts relative to overall engine thrust.

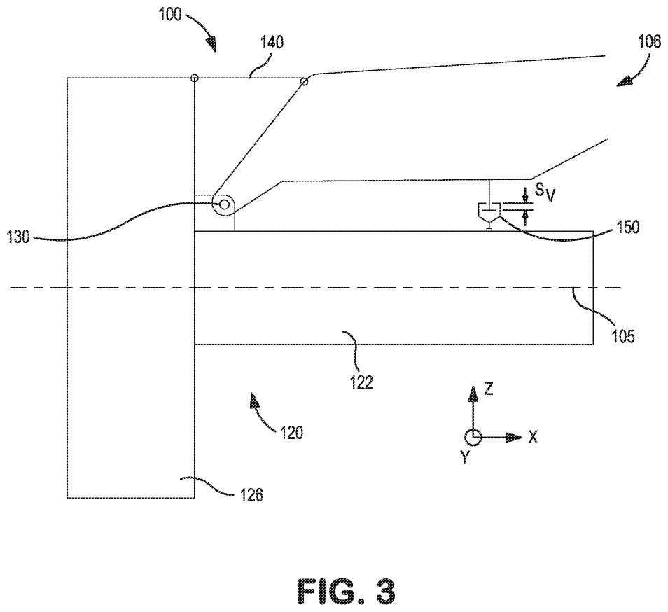

Referring to the embodiment illustrated in FIG. 3, aft mount 150 is configured to begin to react vertical load after a defined pitch deflection is reached (e.g., pitch deflection results in vertical displacement of aft mount 150). Prior to this point, aft mount 150 does not react vertical loads. First and second forward mounts 130 and 140 react the pitch moment at least until the pitch deflection reaches a specific point. At larger pitch deflections, however, the pitch moment is shared by aft mount 150 in proportion to the relative stiffnesses of the load paths through second forward mount 140 and aft mount 150. In some embodiments, the defined value of the deflection at which the vertical load begins to be reacted is set so that under normal operating conditions, aft mount 150 does not react vertical loads. In some embodiments, normal operating conditions involve vertical loading of between about 0.5 g and 1.5 g, and operation over the full thrust range and normal flight conditions (e.g., take-off through landing) of engine 120 and the aircraft. This ability to react vertical loading beyond a set deflection alleviates potential stress issues in core 122 at infrequent high g conditions. This, in turn, would provide the benefit of reduced bending moment in core 122 while minimizing the weight needed to support the full flight spectrum loads.

In some embodiments, by incorporating second forward mount 140 into mounting system 100, thrust link systems are not necessary and need not be provided within the area of core 122 of engine 120, thereby freeing space that is at a premium with new classes of high bypass engines. In addition, by positioning second forward mount 140 on an outboard side of engine 120, it is in a cooler environment compared to conventional thrust links, permitting the use of lightweight materials. In some embodiments, this positioning is also outside of fire zones, unlike mounts in or around core 122. Furthermore, where such conventional thrust links are not needed to span the width of core 122 of engine 120, mounting system 100 is substantially aligned with pylon 106 and is narrower in width compared to conventional mounting systems. In some embodiments, second forward mount 140 is located in line with pylon- and nacelle-flow bifurcations. Any additional strengthening of engine 120 in this region has minimal impact on engine flow paths.

In addition, in some embodiments, this second pitch moment load path is also used as a fail-safe load path in the event of the loss of load carrying capability of second forward mount 140, such as with fatigue failure or discrete source damage events like rotor burst or fire. In this case, the full pitch moment is reacted by the vertical reaction of aft mount 150 and the vertical load capability of first forward mount 130. In some embodiments, the design of aft mount 150 is configured to begin to carry vertical loads only in the event of failure of second forward mount 140, providing added redundancy without significant weight. The use of a failsafe load path as described permits alternate designs and/or inspection means for the system that provide benefit in weight and maintenance costs. In some embodiments, this configuration also avoids the need for redundancy within second forward mount 140 itself, simplifying the design.

In some embodiments, a controlled vertical load capability is added for all pitch deflections, making the system non-isostatic. The primary pitch reaction is the same as discussed above, but aft mount 150 has a limited vertical load carrying capability based upon a controlled spring rate to minimize the stress and deflection of the core of engine 120 due to gravity. This configuration results in some small portion of the pitch moment being reacted by aft mount 150. In some embodiments, the controlled spring rate is a nonlinear spring type, where the load remains relatively constant (e.g., constant force spring or low spring rate spring with high preload) offsetting 1G effects while permitting motions from thrust pitch moment or nacelle aerodynamic load application without inducing an additional bending moment in engine 120. This nonlinear spring rate can be provided by any of a variety of mechanisms, such as by fluid or gas pressure, or by elastomeric or metallic nonlinear springs (e.g., Belleville washers or buckling columns, preloaded spring joints). Alternatively, in some embodiments, this controlled spring rate is a linear spring type using a preloading arrangement (e.g., deflection set) to take up a set load at the 1G condition but minimize additional loading during further deflections induced from the thrust or aerodynamic pitch moments noted earlier. In any particular arrangement, aft mount 150 having a limited vertical load carrying capability is beneficial in some situations as the length-to-diameter ratio of core 122 increases and deflection due to gravity loading becomes significant.

In addition, in some embodiments, second forward mount 140 is designed to act as a structural-mechanical “fuse” and at least partially fail under a fan blade off event to alleviate load transmission to pylon 106 and the airframe. Those having ordinary skill in the art will recognize that a fan blade off event can include a rotor burst, bird strike, or any of a variety of similar events. This “fusing” can be done by any of a variety of fuse types known to those having skill in the art, such as buckling, pin shear, attachment failures, etc. In any configuration, such “fusing” involves effecting a reduction in the effective stiffness of second forward mount 140 (i.e., from a first stiffness value to a relatively lower second stiffness value of about 50% or less) as a structural connection between structure 104 and engine 120 and/or a reduction in the stiffness of the materials of second forward mount 140.

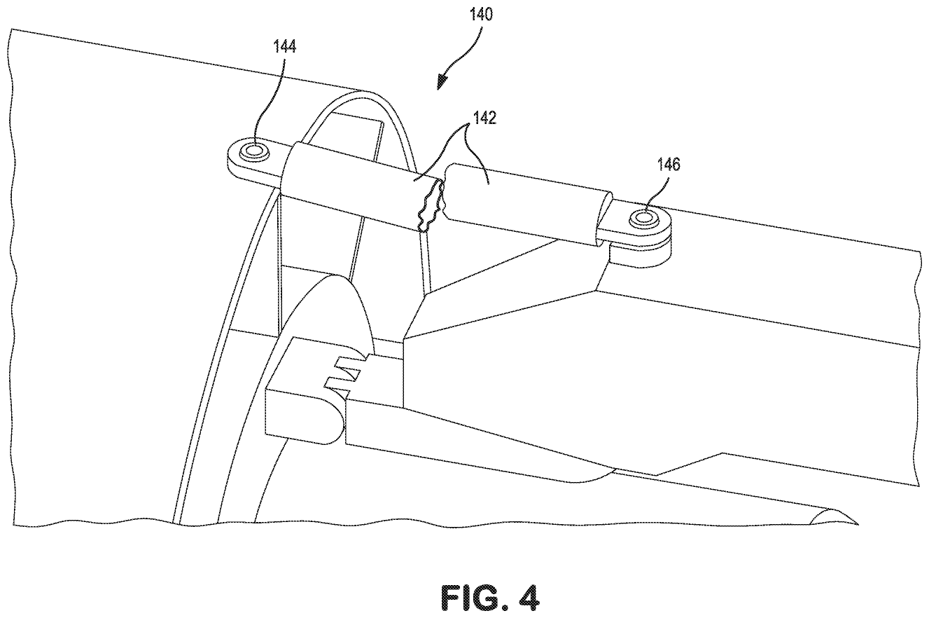

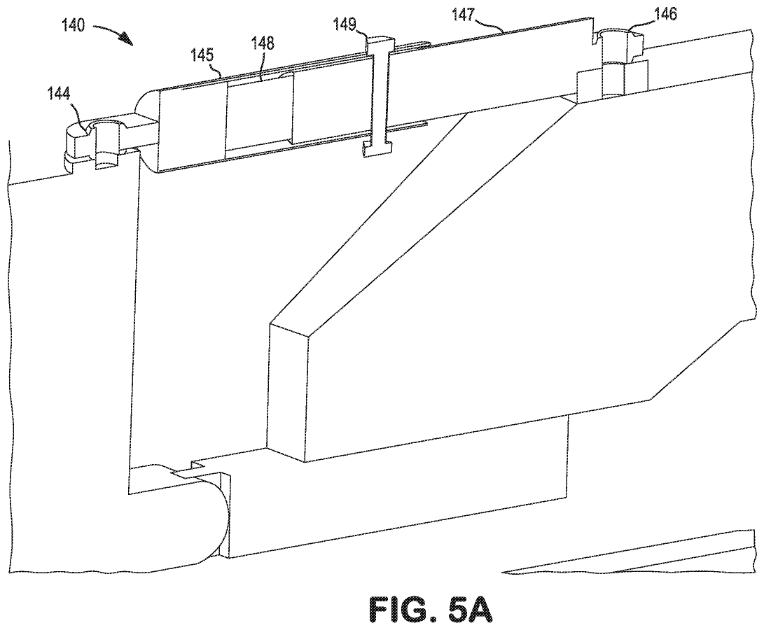

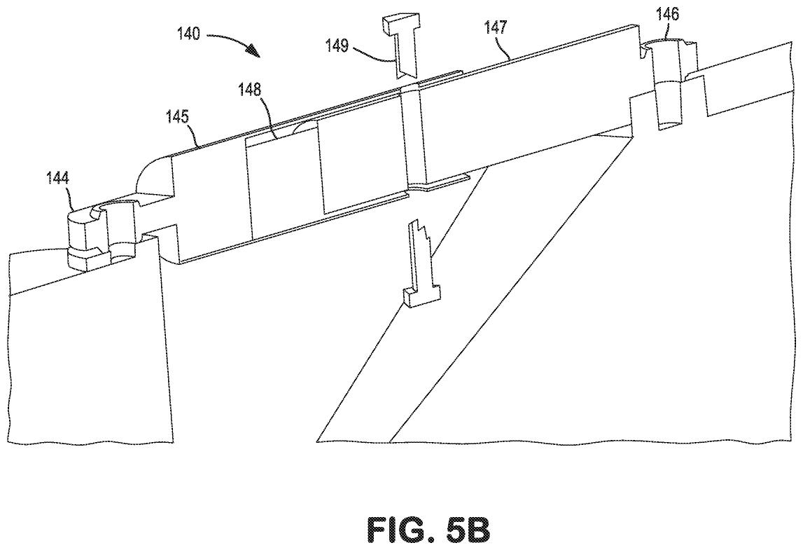

As shown in FIG. 4, for example, in some embodiments, second forward mount 140 is configured to at least partially decouple from the engine (e.g., by buckling or shearing at a point along the length of connecting rod 142 or by detaching from one of engine 120 or pylon 106) at a defined threshold condition, such as aircraft ultimate maneuver loads. In alternative embodiments, such as is illustrated in FIGS. 5A and 5B, second forward mount 140 is configured as a connecting rod 142 that includes a first rod portion 145 coupled to engine 120 (e.g., at first fitting 144) and a second rod portion 147 coupled to pylon 106 (e.g., at second fitting 146). In this embodiment, first and second rod portions 145 and 147 are substantially fixedly coupled under normal operating conditions. In the embodiment illustrated in FIG. 5A, first rod portion 145 includes a hollow end into which a stiffness flexing element 148 (e.g., an elastomer, a metallic mesh, a metal spring) and a second rod portion 147 is insertable. In some embodiments, first and second rod portions 145 and 147 are held together by a fastener 149 (e.g., a pin inserted through both of first and second rod portions 145 and 147) or other coupling device.

In this configuration, upon a defined threshold condition being met (e.g., a rotor burst, bird strike, or other fan blade off event), fastener 149 is disengaged such that first and second rod portions 145 and 147 are at least partially decoupled from one another (e.g., movable in a longitudinal direction). Such a disengagement of fastener 149 is illustrated in FIG. 5B. In this state, the effective stiffness of second forward mount 140 is reduced, but it is still capable of load reaction. In some embodiments, the composition and/or configuration of stiffness flexing element 148 is designed to achieve a desired stiffness and/or damping with respect to relative movement of first and second rod portions 145 and 147. Although some embodiments of second forward mount 140 being configured to “fuse” as shown and described, those having ordinary skill in the art will recognize that any of a variety of other configurations can be implemented to achieve a change in stiffness of second forward mount 140 at the defined threshold condition.

Regardless of the particular configuration, after “fusing” second forward mount 140, aft mount 150 reacts all pitch loading with first front mount 130 due to the axial distance between them. In some embodiments, aft mount 150 under this condition has a stiffness value such that the overall pitch stiffness is significantly reduced. The additional motion capability and lower stiffness of this second pitch restraint state for mounting system 100 permits the mass of engine 120 to react more of the unbalance loads and reduce load transmission to the airframe. In some embodiments, the spring rate characteristics of aft mount 150 are designed to provide this load reduction. In addition, in some embodiments, this softer system remains in effect after the fan blade off event and reduces the windmilling loads by providing a more compliant engine mount system in the pitch direction.

For reference, with both the present configuration of mounting system 100 and similar current mount systems, the center of gravity of engine 120 is very near first forward mount 130, and fan casing 126 extends well forward of this mount point. In a fan blade off condition, the unbalance at fan casing 126 generates large vertical and lateral loads (e.g., rotating unbalance) that also results in a large pitch and yaw moment. The stiffness of pylon 106 at first forward mount 130 is relatively low compared to that at aft mount 150 due to the cantilever design of pylon 106. With conventional mount designs, this forward compliance helps to reduce peak loads and subsequent loading in windmilling at the forward mount, but due to the stiff nature of pylon 106 at the rear, especially in the vertical direction, the pitch motion generates high loads. According to the present subject matter, however, by having aft mount 150 configured as a soft vertical mount and permitting larger motions, these loads can be reduced both in windmilling and initial fan blade off conditions. The unbalance forces are then more directly reacted by the engine mass and inertia.

In some alternative embodiments, similar functionality is achieved by employing aft mount 150 in a conventional arrangement (e.g., without second forward mount 140). In this embodiment aft mount 150 carries vertical loads under normal conditions and “fusing” under high load to a softer state (e.g., have a stiffness that is reduced from a first stiffness value to a relatively lower second stiffness value of about 50% or less in the vertical direction upon a fan blade off event) that permits larger motion. Although the method of “fusing” second forward mount 140 of mounting system 100 discussed above (e.g., buckling of a link) may be easier in some embodiments since the location away from core 122 is generally cooler and space is less constrained, there are advantages to using a more conventional mounting arrangement in which vertical load is supported at aft mount 150. In some embodiments of such a more conventional configuration, however, aft mount 150 is configured in a way such that the vertical and roll load paths are decoupled from one another. In this way, upon a fan-blade-off event, aft mount 150 is configured to have a reduced stiffness in the vertical direction. In some embodiments, aft mount 150 is further configured to be adjustable such that the pitch orientation is adjustable.

In some embodiments, aft mount 150 is configured to provide support to the aft of engine 120 without reacting the thrust or aerodynamic applied pitch moment. In such embodiments, a vertical load support 152 provides support to the aft side of engine 120 to offset the bending moment on the core of engine 120 due to vertical inertia (G-loading) load on engine 120. When incorporated into mounting system 100 described herein, the full pitch moment on the installation is reacted by first forward mount 130 (and second forward mount 140 if present). These loads are from the aerodynamic moment on the inlet and the offset of the thrust reaction relative to longitudinal axis 105 of engine 120 (e.g., thrust line of the engine) as noted. An internal bending moment within engine 120 also exists due to the weight of engine 120. If engine 120 is cantilevered as described, the 1G gravitational force and any additional vertical maneuvers result in increased core deflection due to the cantilever. Vertical load support 152, when coupled with the mounting system 100, further reduces core bending by significantly reducing even G-load-induced bending relative to a cantilevered core.

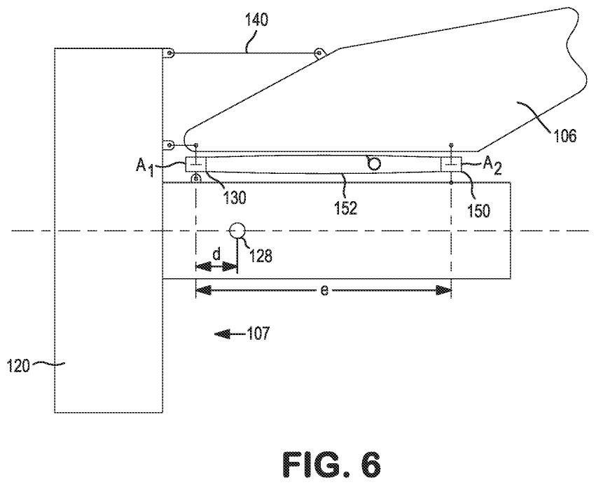

In the embodiment illustrated in FIG. 6, vertical load support 152 comprises a fluid-coupled loading device at first forward mount 130 and at aft mount 150. In some embodiments, vertical load support 152 includes a piston at each of first forward mount 130 and at aft mount 150, the pistons being in communication with fluid chambers that are connected by a fluid conduit such that fluid can pass between the fluid chambers when acted on by a force. In this arrangement, vertical load support 152 is oriented and coupled to the mounts such that vertical loads cause compression in the fluid, but pitch loads are not reacted as the fluid is pumped from first forward mount 130 to aft mount 150 or vice versa. This arrangement is the inverse of a fluid torque restraint, since rather than reacting torque and permitting vertical loading, it reacts vertical loads while permitting torque with little or no restraint. In some embodiments, the sizing of the piston areas at first forward mount 130 and aft mount 150 is designed to ensure that the vertical load sharing split between first forward mount 130 and aft mount 150 remains constant regardless of the pitch motion or loading. In some embodiments, this split is defined as follows:

$${A}_{1} = ( \frac{e}{d} - 1 ) {A}_{2}$$

where A₁ is the piston area at first forward mount 130, A₂ is the piston area at aft mount 150, d is a (non-zero) distance between a center of gravity 128 of engine 120 and a point at which first forward mount 130 is connected to core 122, and e is a distance between the point at which first forward mount 130 is connected to core 122 and a point at which aft mount 150 is connected to core 122. This arrangement helps to minimize total deflection of the aft side of engine 120 due to maneuver loads in the vertical direction while ensuring pitch is controlled by the first and second forward mount paths.

In some embodiments, vertical load support 152 is configured such that the fluid path is designed to provide damping in the pitch motion direction under fan blade off conditions as noted above where second forward mount 140 and/or a vertical-load-bearing element of aft mount 150 may “fuse” under high loads. In this way, the added damping helps to control the engine pitch mode response in the run down of engine 120 after the fan blade off event as the engine speed crosses engine/airframe modes. In addition, the damping generated reduces pitch-related mode responses during any windmilling conditions. This effect reduces loads transmitted to the airframe under these conditions. In this condition, the deflection gap shown in FIG. 3 may be included to provide a mechanism for reacting pitch moment beyond a specific defined deflection under this failed condition. In embodiments in which second forward mount 140 is designed to “fuse” during a fan blade off condition as discussed above, this ability of vertical load support 152 to react pitch moments adds a second load path to at least partially compensate for the loss of the pitch restraint provided by second forward mount 140.

Furthermore, as the configurations of mounting system 100 discussed above are configured to substantially decouple the vertical load carrying at aft mount 150 from the ability to react torque in the X direction, an additional feature enabled by such configurations is the ability to control the engine pitch orientation relative to pylon 106 and wing 108 by changing the length of second forward mount 140 and/or aft mount 150. In some embodiments, second forward mount 140 is configured to be lengthened or shortened such as by a ball screw, hydraulic pressure with position control, or other structure. In this way, the engine is rotatable about first forward mount 130 as second forward mount 140 changes length. In some embodiments, the mechanism that decouples the vertical load and roll moment reaction at aft mount 150 (e.g., a torque tube or fluid torque restraint) accommodates this movement by accommodating the vertical motion at the rear. In such embodiments, the vertical position of aft mount 150 relative to pylon 106 is adjustable, but this adjustability does not affect loading because no vertical load is reacted at aft mount 150 or because the force is substantially constant relative to vertical displacement in accordance with the exemplary embodiments discussed above. Redundancy and safety are provided with dual load path or redundancy in second forward mount 140 or in combination with a fail-safe catch at aft mount 150.

In any configuration, the engine pitch angle is set to optimize airflow in interaction with wing 108 to reduce aircraft drag. This angle is optimized to flight conditions based upon the aircraft weight and required flight conditions. In conventional mounting arrangements, the engine-to-pylon relative pitch angle is set for maximum overall efficiency for a single cruise condition and accounts for deflection of engine 120, pylon 106, and wing 108 under the loads at this single condition design point. Other conditions off of this single weight, airspeed, and/or altitude design point often result in operation at reduced efficiency. Accordingly, the ability to change the pitch angle through adjustment of mounting system 100 permits optimization based on changing flight conditions throughout the flight segment, for example as the aircraft weight is reduced due to fuel burn or airspeed changes are required with resulting reduction in drag and fuel burn.

In addition, the pitch angle change feature benefits the anti-ice system of the nacelle by permitting a reduction in the angle of attack of the nacelle relative to the incoming airflow, minimizing the asymmetric flow pattern and ice build-up during icing conditions. This benefit could reduce the power requirements for anti-icing and improve overall propulsion efficiency.

In some alternative embodiments, the pitch change capability discussed above is added to a more conventional mounting system. In this case, first forward mount 130 reacts vertical and lateral loading as well as thrust. Aft mount 150 reacts vertical and lateral loads and torque about the X-axis. Moments about the Y- and Z-axes are reacted by the lateral and vertical loads at the rear and the axial displacement between the forward and aft mounts. To provide a mechanism to adjust the relative pitch to pylon 106, the vertical load reaction capability and moment reaction capability about the X-axis of aft mount 150 are decoupled by the use of a torque-tube type mounting similar to one defined in U.S. Pat. No. 5,108,045. In some embodiments, the torque-tube arrangement includes elastomer at the tube pivots, while in other embodiments, hard bearings are used, such as those known in the use of torque tubes in turboprops. With the decoupling completed by the torque tube, in some embodiments, a vertical positioning actuator (e.g., either ball screw type or fluid force device like a hydraulic mount) is located at aft mount 150 to set the vertical position relative to pylon 106.

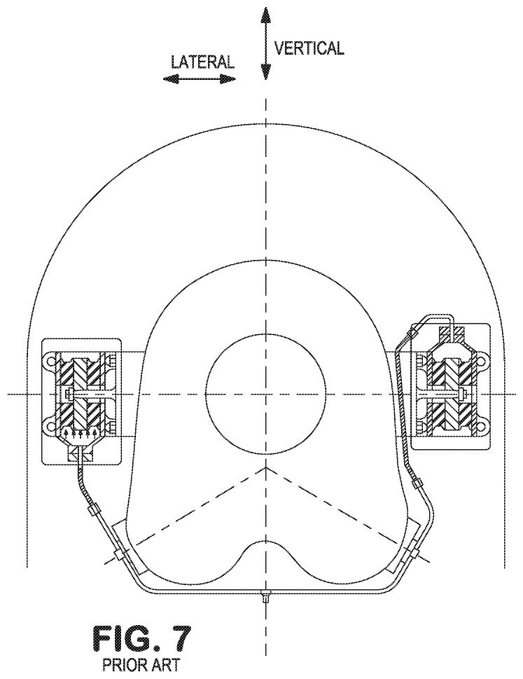

Furthermore, rather than using a torque tube device to decouple the vertical load and roll moment reaction of aft mount 150, a fluidic torque restraint type system is used to generate the same result. Such devices are known and in use on turboprop and turboshaft aircraft engine installations to decouple engine torque from vertical load reaction. (See, e.g., U.S. Pat. No. 5,127,607) Such configurations provide high roll stiffness with very low or zero vertical stiffness. High roll stiffness is similar to that of existing known mount systems. Very low vertical stiffness is about 0% to about 10% of the pitch moment reacted at the rear mount. An example of such an arrangement is shown in FIG. 7.

Torque loading generates hydrostatic compression in the fluid while vertical motion causes transfer of the fluid from one mount side to the other. In some embodiments, the mounts are an elastomeric-fluid-containment-style as shown in FIG. 7, although those having skill in the art will recognize that such a system can be arranged simply using two hydraulic cylinders of typical construction. In any configuration, vertical positions are changed by a secondary actuation device as discussed above.

In the configurations discussed above in which a fluid torque restraint is provided at the rear of mounting system 100 to provide the decoupling of vertical loads and the moment reaction about the X-axis, the fluid torque restrain is further tuned to provide high damping from the fluid flow under windmilling or fan blade off events, as these would generate vertical displacement of engine 120 relative to pylon 106.

Although exemplary configurations of mounting system 100 are described above, any of a variety of alternative configurations are contemplated that would likewise achieve the benefits discussed. For example, mounting system 100 could use a forward mount configuration that is more conventional, with thrust links and a whiffle tree, as shown in the mount system of FIG. 1 of U.S. Pat. No. 7,232,091, with thrust links from the forward main fitting to the engine, or the forward mount could attach at a single point to the engine using a single monoball-type fitting or any other adaptation that reacts thrust at a forward mount point. In addition, for aft mount 150 to provide the required torque and lateral restraint, a torque tube arrangement similar to U.S. Pat. No. 5,108,045 or 4,805,851 could be adapted with or without laminated elastomer elements. A fluid torque restraint could be adapted as well (See, e.g., U.S. Pat. No. 5,127,607). Providing means to meet the fail-safe requirements will be needed for this type of arrangement, but are not prohibitive to the general load path approach.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

1. An engine mounting system comprising:
a first forward mount configured for connection between a structure of an aircraft and a first forward part of an engine of the aircraft, the first forward mount being configured to react forces generated in each of a longitudinal direction parallel to a longitudinal axis of the engine, in a lateral direction transverse to the engine, and in a vertical direction;
an aft mount configured for connection between the structure and an aft part of the engine, the aft mount being configured to react forces generated in the lateral direction and to react moments about the longitudinal direction; and
a second forward mount configured for connection between the structure and a second forward part of the engine, the second forward mount being configured to react forces generated in the longitudinal direction;
wherein the second forward mount is offset by a distance from the first forward mount such that the reaction of first and second forwards mounts to forces in the longitudinal direction reacts moments about the lateral direction.

2. The engine mounting system of claim 1, wherein the first forward part of the engine comprises a forward part of a core of the engine, the aft part of the engine comprises an aft part of the core, and the second forward part of the engine comprises a fan casing of the engine radially outward from the longitudinal axis of the engine with respect to the first forward mount.

3. The engine mounting system of claim 1, wherein the aft mount is configured to react forces generated in the vertical direction after a pitch deflection of the engine exceeds a defined value.

4. The engine mounting system of claim 1, wherein the aft mount is configured to react forces generated in the vertical direction based on a controlled spring rate.

5. The engine mounting system of claim 1, wherein the aft mount comprises a fluid torque restraint configured to provide high roll stiffness with very low or zero vertical stiffness.

6. The engine mounting system of claim 1, wherein the second forward mount comprises a connecting rod extending generally in the longitudinal direction between the structure and the fan casing.

7. The engine mounting system of claim 1, wherein the second forward mount is configured to have a stiffness that is reduced from a first stiffness value to a relatively lower second stiffness value of about 50% or less upon a fan blade off event, and wherein the first forward mount and the aft mount are configured to react moments about the lateral direction following such an event.

8. The engine mounting system of claim 7, wherein the second forward mount has a non-zero stiffness upon the fan blade off event such that the second forward mount remains configured to at least partially react forces generated in the longitudinal direction.

9. The engine mounting system of claim 7, wherein the second forward mount is configured to at least partially dampen forces generated in the longitudinal direction upon the fan blade off event.

10. The engine mounting system of claim 1, wherein a length of the second forward mount is adjustable to change a pitch orientation of the engine relative to the structure.

11. The engine mounting system of claim 1, comprising a vertical load support coupled to the first forward mount and the aft mount, the vertical load support being configured to react loads in the vertical direction without reacting moments about the lateral direction at the aft mount.

12. The engine mounting system of claim 11, wherein the vertical load support comprises a fluid-coupled loading device and the engine mounting system being configured for vertical loads to cause compression in a fluid contained therein, but pitch loads are not reacted as the fluid is pumped between the first forward mount and the aft mount.

13. An engine mounting system comprising:
an engine including a fan casing;
a structure fixed under a wing;
a first forward mount configured for mounting the engine to the structure;
an aft mount configured for mounting the engine to the structure; and
a second forward mount configured for opposing moments about a transverse lateral axis that is substantially orthogonal to a longitudinal axis of the engine, the second forward mount comprising a connecting rod configured for opposing moments about the transverse lateral axis of the engine, the connecting rod being directly connected to the structure and to the fan casing of the engine;
wherein the aft mount is configured to react forces generated in a vertical direction only after a pitch deflection of the engine exceeds a defined value.

14. A method for supporting an engine on an aircraft, the method comprising:
at a first forward mount connected between a structure of an aircraft and a first forward part of an engine of the aircraft, reacting forces generated in a longitudinal direction parallel to a longitudinal axis of the engine, in a lateral direction transverse to the engine, and in a vertical direction;
at an aft mount connected between the structure and an aft part of the engine, reacting forces generated in the lateral direction and reacting moments about the longitudinal direction; and
at a second forward mount connected between the structure and a second forward part of the engine, reacting forces generated in the longitudinal direction;
wherein the second forward mount is offset by a distance from the first forward mount such that reacting forces in the longitudinal direction by the first and second forwards mounts reacts moments about the lateral direction.

15. The method of claim 14, wherein the first forward part of the engine comprises a forward part of a core of the engine, the aft part of the engine comprises an aft part of the core, and the second forward part of the engine comprises a fan casing of the engine radially outward from the longitudinal axis of the engine with respect to the first forward mount.

16. The method of claim 14, comprising, after a pitch deflection of the engine exceeds a defined value, reacting forces generated in the vertical direction at the aft mount.

17. The method of claim 14, comprising reacting forces generated in the vertical direction at the aft mount based on a controlled spring rate.

18. The method of claim 14, comprising, at a vertical load support coupled to the first forward mount and the aft mount, reacting loads in the vertical direction without reacting moments about the lateral direction at the aft mount.

19. The method of claim 18, wherein reacting loads in the vertical direction without reacting moments about the lateral direction at the aft mount comprises:
compressing a fluid contained in a fluid-coupled loading device to react vertical loads; and
pumping the fluid between the first forward mount and the aft mount in response to moments about the lateral direction.

20. The method of claim 14, comprising adjusting a length of the second forward mount (140) to change a pitch orientation of the engine relative to the structure.

21. The method of claim 20, wherein adjusting a length of the second forward mount comprises optimizing airflow in interaction with a wing of the aircraft based on changing flight conditions.

22. The method of claim 20, wherein adjusting a length of the second forward mount comprises minimizing asymmetric flow patterns about the engine and ice build-up during icing conditions.

23. The method of claim 14, comprising, upon a fan blade off event:
reducing a stiffness of the second forward mount from a first stiffness value to a relatively lower second stiffness value of about 50% or less; and
reacting moments about the lateral direction at the first forward mount and the aft mount.

24. The method of claim 23, wherein reducing the stiffness of the second forward mount comprises reducing the stiffness of the second forward mount to a non-zero value upon the fan blade off event such that the second forward mount at least partially reacts forces generated in the longitudinal direction.

25. The method of claim 23, wherein the second forward mount at least partially dampens forces generated in the longitudinal direction upon the fan blade off event.

26. An engine mounting system comprising:
at least one forward mount configured for connection between a structure of an aircraft and a forward part of an engine of the aircraft, the at least one forward mount being configured to react forces generated in a longitudinal direction parallel to a longitudinal axis of the engine, in a lateral direction transverse to the engine, and in a vertical direction; and
an aft mount configured for connection between the structure and an aft part of the engine, the aft mount being configured to react forces generated in the lateral direction and in the vertical direction and to react moments about the longitudinal direction;
wherein one or both of the at least one forward mount or the aft mount is configured to have a stiffness that is reduced from a first stiffness value to a relatively lower second stiffness value of about 50% or less in the vertical direction upon a fan blade off event.

27. The engine mounting system of claim 26, wherein the aft mount is configured to have a stiffness in the vertical direction that is reduced from the first stiffness value to the relatively lower second stiffness value of about 50% or less upon the fan blade off event.

28. The engine mounting system of claim 27, wherein a length of the aft mount is adjustable to change a pitch orientation of the engine relative to the structure.

29. The engine mounting system of claim 27, wherein the aft mount is configured to at least partially dampen forces generated in the vertical direction upon the fan blade off event.
